(19) United States
(12) Patent Application Publication
(10) Pub. No.: US 2007/0210971 A1
(43) Pub. Date: Sep. 13, 2007

(54) THIN FILM SWITCH WITH INDUCED ANTENNA EFFECT

(75) Inventor: Feng-Ting Hsu, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: JENSIN INTL TECHNOLOGY CORP., Taipei County (TW)

(21) Appl. No.: 11/682,887

(22) Filed: Mar. 7, 2007

(30) Foreign Application Priority Data
Mar. 7, 2006 (TW) 95107548

(51) Int. Cl. H01Q 1/24

(52) U.S. Cl. 343/702; 343/700 MS; 343/897

(57) ABSTRACT

A thin film switch with induced antenna effect includes two thin films, a touch circuit and an induced antenna circuit. The two films include two opposite inner surfaces and two opposite outer surfaces. The touch circuit includes a plurality of touch portions disposed on the opposite inner surfaces of the two thin films. The induced antenna circuit is disposed on at least one of the outer surfaces and includes at least one inductive element and an inductive loop. The inductive loop of the induced antenna circuit receives an external radio frequency signal and transfers it to the inductive element.

### CROSS-REFERENCE TO RELATED APPLICATION

This application claims the priority benefit of Taiwan application serial no. 95107548, filed Mar. 7, 2006. All disclosure of the Taiwan application is incorporated herein by reference.

### BACKGROUND OF THE INVENTION

1. Field of the Invention

The present invention relates to a thin film switch, and more particularly, to a thin film switch with induced antenna effect.

2. Description of Related Art

Thin film switch technology mainly utilizes the conductive state of two groups of touch circuits on two inner surfaces of two opposite thin films after a contact with each other through a change in their relative locations resulting from an external pressure. In other words, it is a switching action achieved through the contact between corresponding touch portions of the respective touch circuits on two opposite inner surfaces of two thin films. When a number of these thin film switches are grouped together in a design, a pressure input device, for example, the keyboard of a notebook personal computer, the pressure input keypad of an ultra-thin calculator or a toy, is produced.

The conventional thin film switches used in the foregoing input device have a layer of metal thin film coated on the two opposite outer surfaces of the thin films. The metal thin film mainly comprises one or a plurality of metal mesh layers. The metal mesh layers of the conventional metal thin films has a function identical to most metal isolation meshes or isolation meshes fabricated using a shielding material. The isolation mesh shields the thin film switches against the effect of external static electricity, electromagnetic wave or noise interference so that the thin film switches may operate normally.

### SUMMARY OF THE INVENTION

Accordingly, at least one objective of the present invention is to provide a thin film switch with induced antenna effect that facilitates an inductive loop on the thin film switch to receive an externally transmitted radio frequency signal.

At least another objective of the present invention is to provide a keyboard with induced antenna effect that facilitates an inductive loop on the keyboard to receive an externally transmitted radio frequency signal.

To achieve these and other advantages and in accordance with the purpose of the invention, as embodied and broadly described herein, the invention provides a thin film switch with induced antenna effect. The thin film switch comprises two thin films, a touch circuit and an induced antenna circuit. The two films include two opposite inner surfaces and two opposite outer surfaces. The touch circuit includes a plurality of touch portions disposed on the opposite inner surfaces of the two thin films. The induced antenna circuit is disposed on at least one of the outer surfaces.

In one embodiment of the present invention, the foregoing induced antenna circuit includes an inductive element and an inductive loop. The inductive element receives a radio frequency signal through the inductive loop.

In one embodiment of the present invention, the foregoing inductive loop includes a metal wire or a metal mesh.

In one embodiment of the present invention, two of the corresponding touch portions conducts after receiving a pressure and hence constitute a switch.

The present invention also provides a keyboard with induced antenna effect. The keyboard comprises a plurality of keys, a thin film switch and an induced antenna circuit. The thin film switch is used for receiving signals from pressing actions in the keys. The induced antenna circuit is disposed on at least one of the outer surfaces of the thin film switch.

In one embodiment of the present invention, the foregoing thin film switch includes two thin films and a touch circuit. The two thin films include two opposite inner surfaces and two opposite outer surfaces. The touch circuit includes a plurality of touch portions disposed on the two opposite inner surfaces of the two thin films. The induced antenna circuit is disposed on at least one of the outer surfaces.

In one embodiment of the present invention, the foregoing induced antenna circuit includes an inductive element and an inductive loop. The inductive element receives a radio frequency signal through the inductive loop.

In one embodiment of the present invention, the foregoing inductive loop includes a metal wire or a metal mesh.

In one embodiment of the present invention, two of the corresponding touch portions conducts after receiving a pressure and hence constitute a switch.

Accordingly, the thin film switch or keyboard with induced antenna effect is able to pick up the externally transmitted radio frequency signal through the inductive loop of the induced antenna circuit and transmit the signal to the inductive element.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a diagram showing an assembly of a thin film switch with induced antenna effect according to one embodiment of the present invention.

FIG. 1B is a top view of the induced antenna circuit shown in FIG. 1A.

FIG. 2 is a perspective view of a keyboard with induced antenna effect applied to a notebook computer according to the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

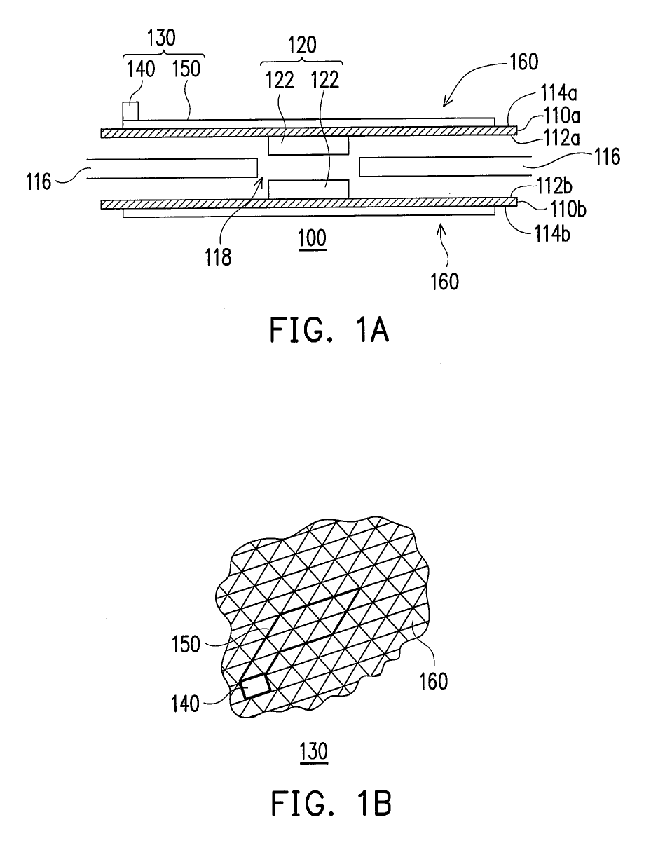

FIG. 1A is a diagram showing an assembly of a thin film switch with induced antenna effect according to one embodiment of the present invention. FIG. 1B is a top view of the induced antenna circuit shown in FIG. 1A. First, as shown in FIG. 1A, the thin film switch 100 with induced antenna effect in the present embodiment includes two thin films 110a and 110b, a touch circuit 120 and an induced antenna circuit 130. The two thin films 110a and 110b have two opposite inner surfaces 112a, 112b and two opposite outer surfaces 114a, 114b. An insulation layer 116 may be disposed between the two inner surfaces 112a, 112b of the two thin films 110a and 110b. Furthermore, the insulation layer 116 has at least one opening 118. The touch circuit 120 has a plurality of touch portions 122 disposed on the two opposite inner surfaces 112a, 112b of the two thin films 110a and 110b. The opening 118 has a dimension suitable for accommodating some relative movement between two opposite touch portions 122 without interfering with their contact.

The induced antenna circuit 130 in the present invention includes an inductive element 140 and an inductive loop 150. The induced antenna circuit 130 is disposed on at least one of the outer surfaces 114a, 114b of the two thin films 110a and 110b. Furthermore, the inductive loop 150 of the induced antenna circuit 130, as shown in FIG. 1B, is disposed as any circuit loop in a metal wire or metal mesh 160 on the outer surfaces 114a, 114b of the two thin films 110a and 110b so long as the circuit loop is able to form more than a two-point contact with the inductive element 140. In the present embodiment, the inductive loop 150 is implemented using a metal mesh as an example. However, in another embodiment (not shown), the inductive loop 150 can also be a straight, spiral or a branched metal wire for receiving an external signal. Aside from serving as an inductive loop, the foregoing metal mesh 160 may also serve as a shield for blocking out static electricity, electromagnetic wave or other interfering noise before the induced antenna effect is initiated.

In one embodiment of the present invention, the inductive element 140 may receive an external radio frequency signal through the inductive loop 150. Furthermore, the inductive element 140 can be an inductive device capable of transmitting radio frequency signal. Moreover, the inductive element 140 can also be an inductive device having a signal identification capability.

In one embodiment of the present invention, a gap separating any two corresponding touch portions 122 is maintained before any external force is applied so that the touch circuit 120 is in an open circuit state. The touch portions 122 of any two corresponding touch portions 122 will contact with each other when an external pressure is applied so that the touch circuit 120 conducts and is transformed into a close circuit state. Therefore, the touch circuit 120 can serve as a pressure-sensitive switch.

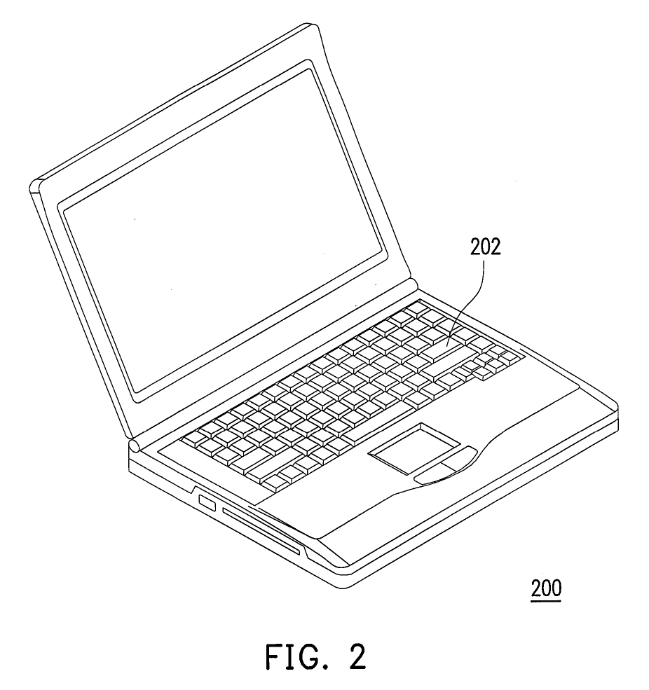

FIG. 2 is a perspective view of a keyboard 200 with induced antenna effect applied to a notebook computer according to the present invention. Refer to FIGS. 1A and 1B for a locally magnified view of the thin film switch 100 and the induced antenna circuit 130 inside the keyboard. The keyboard 200 with induced antenna effect includes a plurality of keys 202, a thin film switch 100 and an induced antenna circuit 130. Since the construction and characteristics of the thin film switch 100 and the induced antenna circuit 130 are identical to the thin film switch 100 and the induced antenna circuit 130 in the foregoing embodiment, a detailed description is omitted.

For example, most common computer operating system can set up a protective mode for protecting the operating system. When a user-preset period has expired without any operation, the operating system will automatically step into a protective mode of operation. In the protective mode, the user has to input a secret code to re-start the computer operating system before using the computer. When the present invention is applied to the keyboard of a notebook computer, the inductive element can be an inductive device with radio frequency signal transmitting and identifying capabilities, and the computer may include an additional group of inductive identification protective systems. After leaving the computer so that the computer enters into a protective mode of operation, the user not only has to input a secret code to release the operating system from the protective mode but also has to utilize an identification element such an identification permit to unlock the locked-up induction identification protection system. In other words, the computer has the double security of not only receiving protection through its operating system but also receiving protection through personal identification. In addition, the inductive element may also be used as a means for receiving other external radio frequency signals, for example, broadcasting signals, satellite television signals, wireless phone signals or remote controller signals so that the conventional thin film switch and keyboard can provide a variety of functions

In summary, the thin film switch and the keyboard with induced antenna effect in the present invention is really a combination of the inductive loop and the inductive element formed by the metal wire or metal mesh inside the thin film switch or the keyboard. Moreover, the inductive element has the simultaneous capacity for emitting, transmitting, identifying and receiving radio frequency signals. After using the inductive loop to receive externally transmitted radio frequency signals or signals emitted from the inductive element and reflected from other objects, the radio frequency signals are transmitted to the inductive element. Hence, beside the key-pressing input function, the conventional thin film switch or the keyboard has the additional capacity for emitting, transmitting, identifying and receiving radio frequency signals.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A thin film switch with induced antenna effect, comprising:
two thin films, having two opposite inner surfaces and two opposite outer surfaces;
a touch circuit, having a plurality of touch portions disposed on the two opposite inner surfaces of the thin films; and
an induced antenna circuit, disposed on at least one of the outer surfaces of the thin films.

2. The thin film switch of claim 1, wherein the induced antenna circuit comprises an inductive element and an inductive loop such that the inductive element receives a radio frequency signal through the inductive loop.

3. The thin film switch of claim 1, wherein the inductive loop comprises a metal wire or a metal mesh.

4. The thin film switch of claim 1, wherein two corresponding touch portions of the touch portions contact and conduct to produce a switching action after pressing them together.

5. A keyboard with induced antenna effect, comprising:
a plurality of keys;
a thin film switch, for receiving signals from pressing actions in the keys; and
an induced antenna circuit, disposed on at least one of the outer surfaces of the thin film switch.

6. The keyboard of claim 5, wherein the thin film switch comprising:
two thin films, having two opposite inner surfaces and two opposite outer surfaces; and
a touch circuit, having a plurality of touch portions disposed on the opposite inner surfaces of the thin films;
wherein the induced antenna circuit is disposed on at least one of the outer surfaces of the thin films.

7. The keyboard of claim 6, wherein the induced antenna circuit comprises an inductive element and an inductive loop such that the inductive element receives a radio frequency signal through the inductive loop.

8. The keyboard of claim 6, wherein the inductive loop comprises a metal wire or a metal mesh.

9. The keyboard of claim 6, wherein two corresponding touch portions of the touch portions contact and conduct to produce a switching action after pressing them together.
